(19) United States
(12) Patent Application Publication
(10) Pub. No.: US 2025/0378672 A1
(43) Pub. Date: Dec. 11, 2025

(54) Effectively Handling Mirrored Objects in An Image

(71) Applicant: ZEBRA TECHNOLOGIES CORPORATION, Lincolnshire, IL (US)

(72) Inventors: Michelle X. Wang, Mount Sinai, NY (US); Darran Michael Handshaw, Sound Beach, NY (US); Dayou Wang, Mount Sinai, NY (US); Edward Barkan, Miller Place, NY (US)

(21) Appl. No.: 18/737,937

(22) Filed: Jun. 7, 2024

(51) Int. Cl. G06V 10/14; G06K 7/10; G06T 3/60; G06T 7/80; G06T 11/00; H04N 23/95

(52) U.S. Cl. CPC G06V 10/14; G06K 7/1096; G06T 3/60; G06T 7/80; G06T 11/00; H04N 23/95; G06T 2210/12

(57) ABSTRACT

Imaging devices, systems, and methods for performing image analysis operations on an object that is partially mirrored are described herein. An example device includes: an imaging assembly configured to capture image data of a first field of view (FOV) and a second FOV; and a computer-readable media storing machine readable instructions that, when executed, cause the imaging device to: capture the image data of the payload-encoding indicia, wherein an at least partially mirrored perspective of the second FOV is mirrored compared to a representative perspective of the first FOV; determine one or more constraints for at least some of the one or more partitions; and perform one or more image analysis operations on the image data based at least on the one or more constraints for the at least some of the one or more partitions.

### BACKGROUND

Scanning systems often have multiple mirrors or other optical components to reflect and/or refract light to an imager. However, as traditional systems continue to expand a range of view, multiple fields of view (FOVs) are incorporated, leading to increased quantities of optical components and lengthened paths. As such, it is desirable to create systems that reduce the number of mirrors by incorporating multiple FOVs with different perspectives. However, introducing new FOVs from different perspectives introduces challenges to the systems in terms of how to perform visual functionalities with different perspectives (e.g., standard and reversed views of the FOV). Similarly, some systems may prefer to use an unequal number of mirrors are particular portions, leading to differing directions of view for the multiple FOVs. As such, a system that is able to piece together multiple FOVs and perform visual operations (e.g., indicia decoding, optical character recognition (OCR), machine vision, etc.) is desirable.

### SUMMARY

In an embodiment, an imaging device for performing image analysis operations on an object that is partially mirrored is provided. The imaging device includes: an imaging assembly configured to capture image data of a payload-encoding indicia, the image data including a first field of view (FOV) and a second FOV; and a computer-readable media storing machine readable instructions that, when executed, cause the imaging device to: (i) capture, using the imaging assembly, the image data, wherein an at least partially mirrored perspective of the second FOV is mirrored compared to a representative perspective of the first FOV; (ii) determine, based on whether a respective partition of one or more partitions of the image data is indicative of a representative view of the payload-encoding indicia in the representative perspective or an at least partially mirrored view of the payload-encoding indicia in the at least partially mirrored perspective, one or more constraints for at least some of the one or more partitions; and (iii) perform one or more image analysis operations on the image data based at least on the one or more constraints for the at least some of the one or more partitions.

In a variation of this embodiment, performing the one or more image analysis operations includes: (i) decoding a first portion of the payload-encoding indicia in a first partition of the one or more partitions to generate a first partial payload; (ii) decoding a second portion of the payload-encoding indicia in a second partition of the one or more partitions to generate a second partial payload; and (iii) generating a decoded payload of the payload-encoding indicia by combining the first partial payload and the second partial payload.

In another variation of the embodiment, determining the one or more constraints includes: determining whether at least one of the first partition or the second partition is mirrored based on one or more flags indicative of an orientation status of the respective partition; wherein decoding the first portion and decoding the second portion are responsive to determining whether at least one of the first partition or the second partition is mirrored based on the one or more flags.

In another variation of the embodiment, decoding the first portion is performed in a first direction; and decoding the second portion is performed in a second direction.

In another variation of the embodiment, generating the one or more partitions is further based on one or more calibrated split lines indicative of the representative view and the at least partially mirrored view.

In yet another variation of the embodiment, the one or more calibrated split lines are based on one or more physical characteristics of the imaging device.

In still yet another variation of the embodiment, the payload-encoding indicia is a 2-Dimensional (2D) payload-encoding indicia.

In another variation of the embodiment, the computer-readable media stores further machine readable instructions that, when executed, cause the one or more processors to: generate, based on a positioning of the payload-encoding indicia in the image data, a bounding box encompassing at least a portion of the image data.

In yet another variation, the computer-readable media stores further machine readable instructions that, when executed, cause the one or more processors to: generate, based on the one or more constraints and the bounding box, a corrected view by mirroring the at least the portion of the image data; wherein performing the one or more image analysis operations includes decoding the corrected view to generate a corrected decode.

In yet another variation, the performing the one or more image analysis operations further includes: decoding a remainder of the image data to generate a mirrored decode; and combining the mirrored decode and the corrected decode.

In still yet another variation, the computer-readable media stores further machine readable instructions that, when executed, cause the one or more processors to: generate, based on the one or more constraints, a corrected view by mirroring at least a partition of the one or more partitions; wherein performing the one or more image analysis operations includes decoding the corrected view.

In another variation, the computer-readable media stores further machine readable instructions that, when executed, cause the one or more processors to: generate, based on the one or more constraints, a corrected view by mirroring the image data; wherein performing the one or more image analysis operations includes decoding the corrected view.

In still another variation, performing the one or more image analysis operations includes: decoding the payload-encoding indicia based on the at least partially mirrored view of the payload-encoding indicia using a decode algorithm configured to decode mirrored barcodes.

In another variation, the imaging assembly includes: a first optical assembly comprising an even number of optical components; and a second optical assembly comprising an odd number of optical components; wherein one of the first FOV or the second FOV is a first optical assembly FOV of the first optical assembly and a different one of the first FOV or the second FOV is a second optical assembly FOV of the second optical assembly.

In a further variation, the even number of optical components includes an even number of mirrors and the odd number of optical components includes an odd number of mirrors.

In another embodiment, a method for performing image analysis operations on an object that is partially mirrored is provided. The method includes: (i) capturing, by one or more processors and using the imaging assembly, image data of a payload-encoding indicia, the image data including a first field of view (FOV) and a second FOV, wherein an at least partially mirrored perspective of the second FOV is mirrored compared to a representative perspective of the first FOV; (ii) determining, by the one or more processors and based on whether a respective partition of one or more partitions of the image data is indicative of a representative view of the payload-encoding indicia in the representative perspective or an at least partially mirrored view of the payload-encoding indicia in the at least partially mirrored perspective, one or more constraints for at least some of the one or more partitions; and (iii) performing, by the one or more processors, one or more image analysis operations on the image data based at least on the one or more constraints for the at least some of the one or more partitions.

In a variation of the embodiment, performing the one or more image analysis operations includes: decoding a first portion of the payload-encoding indicia in a first partition of the one or more partitions to generate a first partial payload; decoding a second portion of the payload-encoding indicia in a second partition of the one or more partitions to generate a second partial payload; and generating a decoded payload of the payload-encoding indicia by combining the first partial payload and the second partial payload.

In another variation of the embodiment, determining the one or more constraints includes: determining, by the one or more processors, whether at least one of the first partition or the second partition is mirrored based on one or more flags indicative of an orientation status of the respective partition; wherein decoding the first portion and decoding the second portion are responsive to determining whether at least one of the first partition or the second partition is mirrored based on the one or more flags.

In yet another variation of the embodiment, decoding the first portion is performed in a first direction; and decoding the second portion is performed in a second direction.

In still another variation of the embodiment, generating the one or more partitions is further based on one or more calibrated split lines indicative of the representative view and the at least partially mirrored view.

In still yet another variation of the embodiment, the one or more calibrated split lines are based on one or more physical characteristics of the imaging device.

In another variation of the embodiment, the payload-encoding indicia is a 2-Dimensional (2D) payload-encoding indicia.

In yet another variation of the embodiment, the method further comprises: generating, by the one or more processors and based on a positioning of the payload-encoding indicia in the image data, a bounding box encompassing at least a portion of the image data.

In still another variation of the embodiment, the method further comprises: generating, by the one or more processors and based on the one or more constraints and the bounding box, a corrected view by mirroring the at least the portion of the image data; wherein performing the one or more image analysis operations includes decoding the corrected view to generate a corrected decode.

In still yet another variation of the embodiment, the performing the one or more image analysis operations further includes: decoding a remainder of the image data to generate a mirrored decode; and combining the mirrored decode and the corrected decode.

In another variation of the embodiment, the method further comprises: generating, by the one or more processors and based on the one or more constraints, a corrected view by mirroring at least a partition of the one or more partitions; wherein performing the one or more image analysis operations includes decoding the corrected view.

In yet another variation of the embodiment, the method further comprises: generating, by the one or more processors and based on the one or more constraints, a corrected view by mirroring the image data; wherein performing the one or more image analysis operations includes decoding the corrected view.

In still another variation of the embodiment, performing the one or more image analysis operations includes: decoding the payload-encoding indicia based on the at least partially mirrored view of the payload-encoding indicia using a decode algorithm configured to decode mirrored barcodes.

In another variation of the embodiment, capturing the image data includes: capturing at least one of the first FOV or the second FOV using a first optical assembly of the imaging assembly, the first optical assembly comprising an even number of optical components; and capturing at least a different one of the first FOV or the second FOV using a second optical assembly of the imaging assembly, the second optical assembly comprising an odd number of optical components.

In a further variation of the embodiment, the even number of optical components includes an even number of mirrors and the odd number of optical components includes an odd number of mirrors.

In yet another embodiment, an imaging device for performing image analysis operations on an object that is partially mirrored is provided. The imaging device includes: an imaging assembly configured to capture image data of an object appearing in a field of view (FOV); one or more processors; and a computer-readable media storing machine readable instructions that, when executed, cause the one or more processors to: (i) capture, using the imaging assembly, the image data of the object appearing in the FOV; (ii) generate one or more partitions for the image data based on a representative view of an indicia appearing in the image data; (iii) generate one or more flags for the one or more partitions based on whether a respective partition of the one or more partitions is representative of the representative view or an at least partially mirrored view of the indicia; and (iv) perform one or more image analysis operations on the image data based at least on the one or more flags for the one or more partitions.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1A illustrates an isometric view of an example bioptic barcode reader;

FIG. 1B illustrates a front perspective view of an example handheld barcode reader as an alternative example imaging device to that of FIG. 1A;

FIG. 1C illustrates a back perspective view of the handheld barcode reader of FIG. 1B;

FIG. 1D illustrates an interior view of the example bioptic barcode reader of FIG. 1A;

FIG. 1E illustrates another interior view of the example bioptic barcode reader of FIG. 1A, similar to FIG. 1D;

FIG. 1F illustrates multiple fields of view of the example bioptic barcode reader of FIGS. 1A, 1D, and 1E;

FIG. 2 illustrates a block diagram of an example imaging device such as the example barcode readers of FIGS. 1A-1F;

FIG. 3A illustrates an image with three fields of view captured by an example imaging device such as the example barcode readers of FIGS. 1A-2;

FIG. 3B illustrates a partitioned view of the image of FIG. 3A;

FIG. 3C illustrates an image with two fields of view captured by an example imaging device such as the example barcode readers of FIGS. 1A-2;

FIG. 3D illustrates a partitioned view of the image of FIG. 3C;

FIG. 4A illustrates a flow diagram of an example method to decode indicia in multiple fields of view by an imaging device, such as those depicted in FIGS. 1A-3C;

FIG. 4B illustrates a flow diagram of an example method to perform OCR on objects in multiple fields of view by correcting a reversed view via an imaging device, such as those depicted in FIGS. 1A-3C;

FIG. 4C illustrates a flow diagram of an example method to perform OCR on objects in multiple fields of view including a reversed view by an imaging device, such as those depicted in FIGS. 1A-3C; and

FIG. 4D illustrates a flow diagram of an example method to perform machine vision analysis on objects in multiple fields of view using a corrected view by an imaging device, such as those depicted in FIGS. 1A-3C.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The example imaging devices disclosed herein utilize an existing assembly in an imaging device in the form of an imaging assembly to capture an image for the device to perform image analysis operations on an object that is partially mirrored in a field of view (FOV). By determining one or more constraints associated with one or more FOVs. For example, the example imaging device may associate one or more flags with one or more partitions representative of one or more FOVs such that the imaging device is able to determine whether a particular partition is a representative (e.g., normal) view or a mirrored (e.g., at least partially mirrored) view. The imaging device may then correct the mirrored view, perform an analysis on both the representative and mirrored views, use a machine learning model trained on reversed views to analyze the mirrored view, and/or otherwise analyze the object in the FOVs.

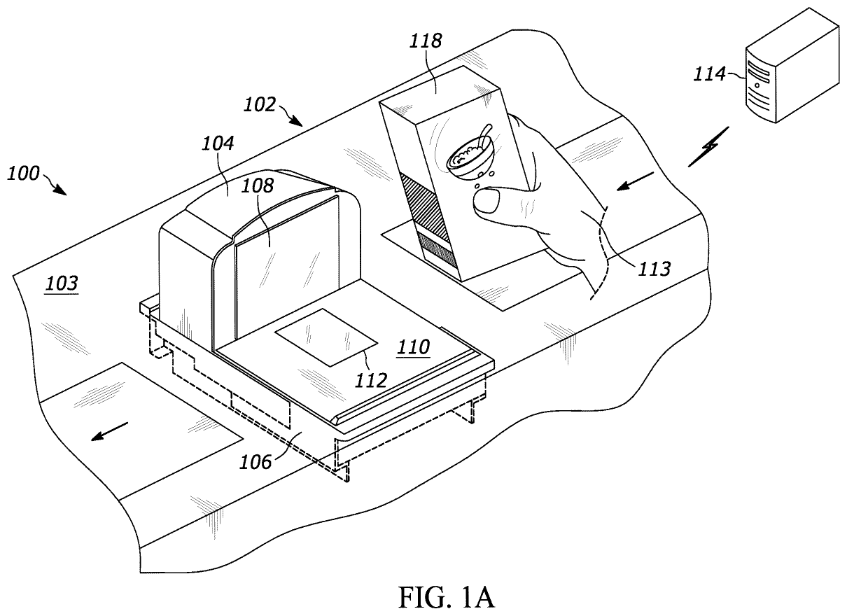

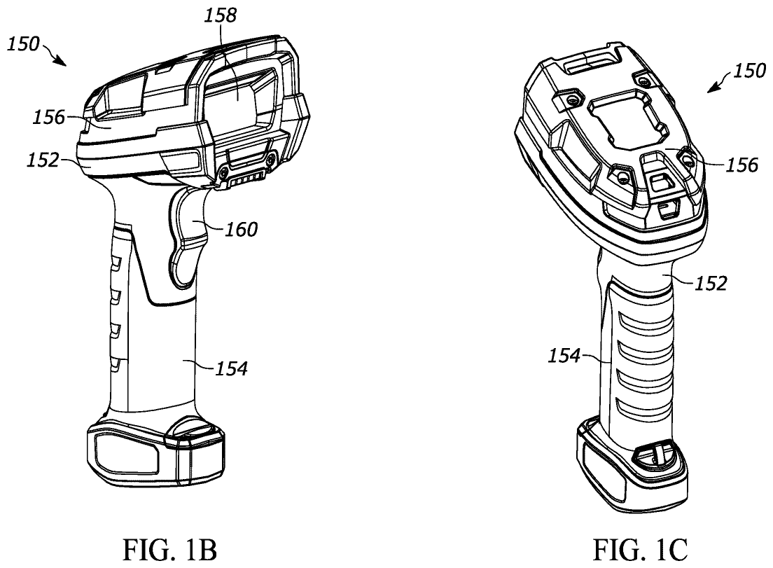

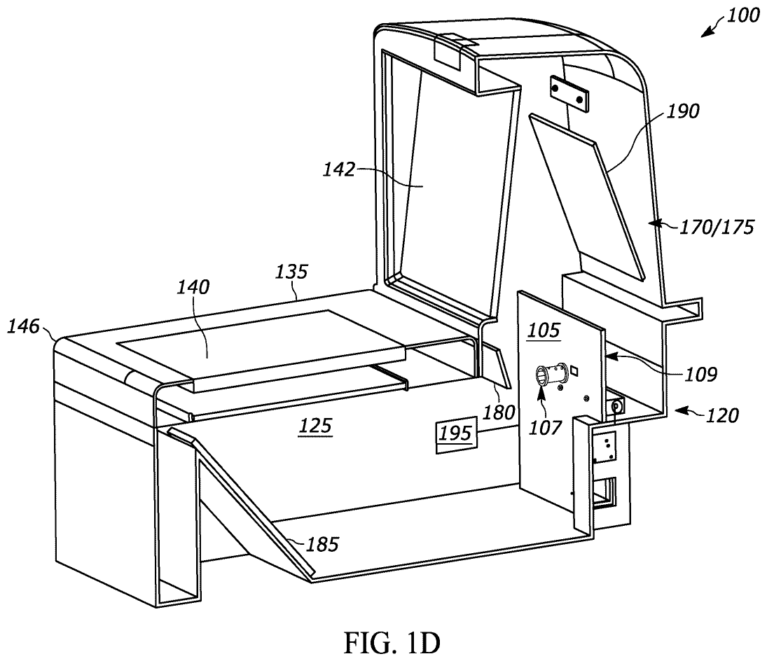

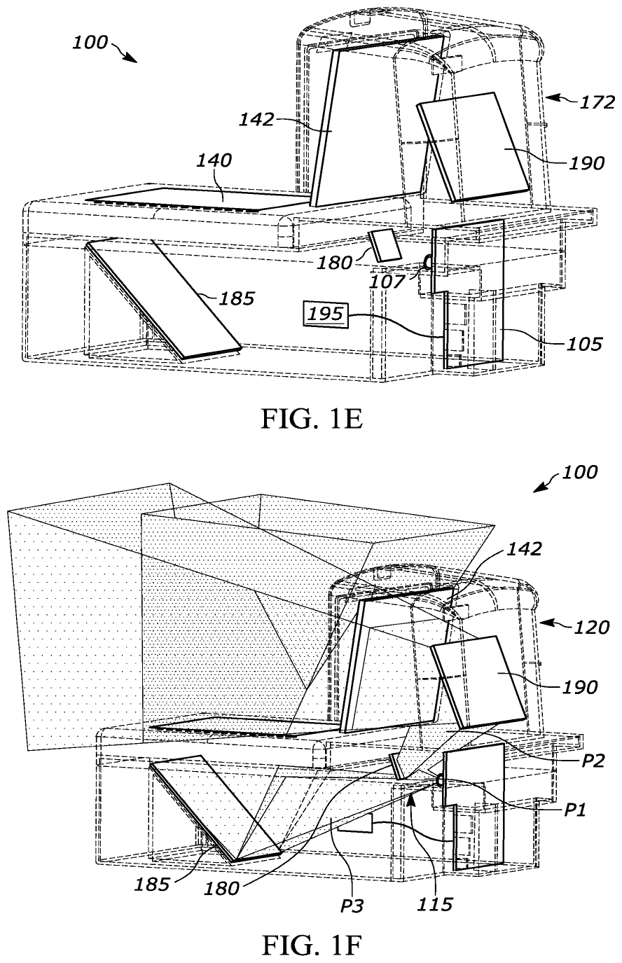

Referring to FIG. 1A, shown therein is an example imaging device embodied in a bi-optic indicia reader 100. In the illustrated example, the bioptic indicia reader 100 is shown as part of a point-of-sale (POS) system arrangement 102 having the bioptic indicia reader 100 positioned within a workstation counter 103. Generally, the indicia reader 100 includes an upper housing 104 (also referred to as an upper portion, upper housing portion, or tower portion) and a lower housing 106 (also referred to as a lower portion, lower housing portion, or platter portion), collectively referred to as a housing. The upper housing 104 can be characterized by an optically transmissive window 108 positioned therein along a generally vertical (or upright) plane and one or more field of view (FOV) which passes through the window 108 and extends in a generally lateral direction. In some examples, a reference to a generally upright window shall be understood to mean a window inclined at an angle of up to 35 degrees relative to a vertical plane. The lower housing 106 can be characterized by a weigh platter 110 or a cover that includes an optically transmissive window 112 positioned therein along a generally horizontal (also referred to as a transverse) plane and one or more FOV which passes through the window 112 and extends in a generally upward direction. In some examples, a reference to a generally horizontal window shall be understood to mean a window inclined at an angle of up to 25 degrees relative to a horizontal plane. The weigh platter 110 is a part of a weigh platter assembly that generally includes the weigh platter 110 and a scale (or load cell) configured to measure the weight of an object placed the top surface of the weight platter 110. By that virtue, the top surface of the weight platter 110 may be considered to be the top surface of the lower housing 106 that faces a product scanning region there above.

In operation, a user 113 generally passes an object 118 across a product scanning region of the indicia reader 100 in a swiping motion in some general direction, which in the illustrated example is right-to-left. A product scanning region can be generally viewed as a region that extends above the platter 110 and/or in front of the window 108 where barcode reader 100 is operable to capture image data of sufficient quality to perform imaging-based operations like decoding a barcode that appears in the obtained image data. It should be appreciated that while items may be swiped past the indicia reader 100 in either direction, items may also be presented into the product scanning region by means other than swiping past the window(s). When the object 118 comes into the any of the fields of view of the reader, the indicia 116 on the object 118 is captured and decoded by the indicia reader 100 (and its respective modules and/or assemblies), and corresponding data (e.g., the payload of the indicia) is transmitted to a communicatively coupled host 114 (commonly comprised of a point of sale (POS) terminal).

Referring next to FIGS. 1B and 1C, illustrated therein is another exemplary imaging device. In particular, handheld imaging device 150 has a housing 152 with a handle portion 154, also referred to as a handle 154, and a head portion 156, also referred to as a scanning head 156. The head portion 156 includes a window 158 and is configured to be positioned on the top of the handle portion 154. The handle portion 154 is configured to be gripped by a reader user and includes a trigger 160 for activation by the user. Optionally included in an embodiment is also a base (not shown), also referred to as a base portion, which may be attached to the handle portion 154 opposite the head portion 156 and is configured to stand on a surface and support the housing 152 in a generally upright position. The handheld imaging device 150 can be used in a hands-free mode as a stationary workstation when it is placed on a countertop or other workstation surface. The handheld imaging device 150 can also be used in a handheld mode when it is picked up off the countertop or base station and held in an operator's hand. In the hands-free mode, products can be slid, swiped past, or presented to the window 158 for the reader to initiate barcode reading operations. In the handheld mode, the handheld imaging device 150 can be moved towards a barcode on a product, and the trigger 160 can be manually depressed to initiate imaging of the barcode.

Other implementations may provide only handheld or only hands-free configurations. In the embodiment of FIGS. 1B and 1C, the handheld imaging device 150 is ergonomically configured for a user's hand, though other configurations may be utilized as understood by those of ordinary skill in the art. As shown, the lower handle 154 extends below and rearwardly away from the body 152 along a centroidal axis obliquely angled relative to a central FOV axis of a FOV of an imaging assembly within the scanning head 152.

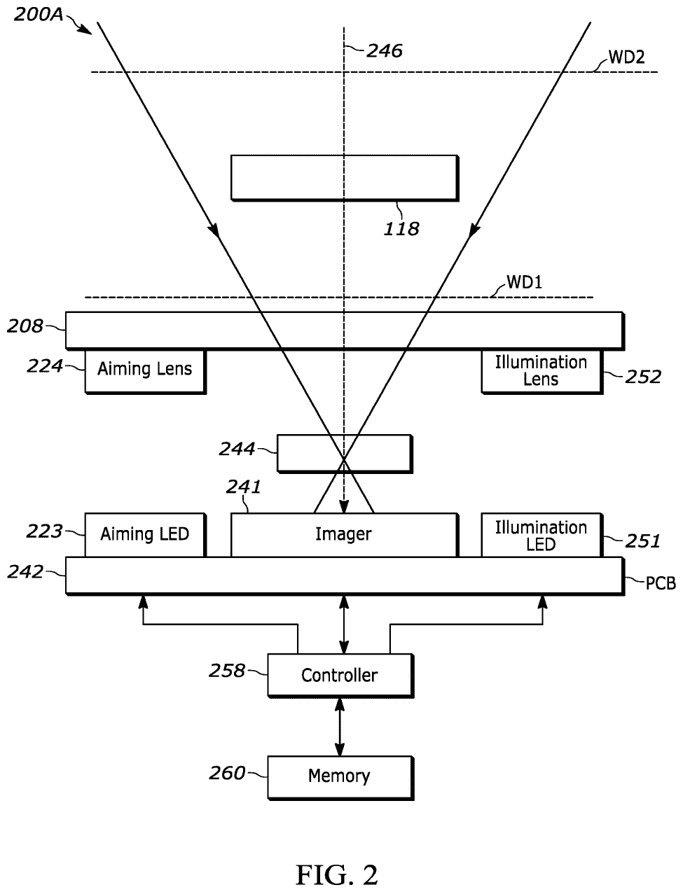

In some embodiments, an imaging assembly includes a light-detecting sensor or imager operatively coupled to, or mounted on, a printed circuit board (PCB) in the handheld imaging device 150 as shown in FIG. 2. In further embodiments, an illuminating light assembly is also mounted in the handheld imaging device 150. The illuminating light assembly may include an illumination light source and at least one illumination lens, configured to generate a substantially uniform distributed illumination pattern of illumination light on and along an object to be read by image capture, as described below with regard to FIG. 2.

Referring next to FIGS. 1D-1F, the bioptic indicia reader 100 of FIG. 1A is illustrated with a first example imaging assembly 109 and a first example set of optical components 170 positioned within interior region 125 of housing 120 and a decode module 195 communicatively coupled to imaging assembly 109 and configured to decode a barcode captured in an image by imaging assembly 109. Imaging assembly 109 includes a printed circuit board 105 with a single image sensor 107 and has a primary FOV 115. Printed circuit board 105 is aligned generally perpendicular to upper surface 135 and printed circuit board 105 and image sensor 107 are arranged to direct primary FOV 115 generally parallel to upper surface 135 and towards distal edge 146 of upper surface 135. The bioptic indicia reader 100 additionally includes decode module communicatively coupled to imaging assembly 109. The bioptic indicia reader 100 may include additional or alternate components.

Optical components 170 are configured to divide primary FOV 115 and include a mirror arrangement 175 with a splitter mirror 180, a first mirror 185, and a second mirror 190. Splitter mirror 180 is positioned directly in a first path P1 of a first portion of primary FOV 115 and is configured to split primary FOV 115 along a horizontal axis and redirect the first portion of primary FOV 115 from first path P1 to a second path P2 towards second mirror 190. Splitter mirror 180 can be positioned to split primary FOV 115 in any proportion desired. For example, primary FOV can be split such that the first and second portions of primary FOV 115 are equal, the first portion is 0-25% larger than the second portion, or the second portion is 0-25% larger than the first portion, depending on the configuration and desired use of bioptic indicia reader 100. Second mirror 190 is positioned directly in second path P2 and is configured to redirect the first portion redirected from splitter mirror 180 through generally upright window 142. Depending on the implementation, primary FOV 115 may be a representative FOV (e.g., display a normal image when captured) in contrast to a secondary FOV (not shown) that may be mirrored (e.g., reversed) when compared to primary FOV 115. Similarly, the first portion of primary FOV 115 may be the representative view and the second portion may be mirrored when compared to the first portion.

The first portion of primary-field-of view 115 that is redirected from second mirror 190 through generally upright window 142 can fill 50-100% of generally upright window 142. In some implementations, an area of the first portion of primary FOV 115 redirected through generally upright window 142, taken along a plane of generally upright window 142, is greater than an area of generally upright window 142 such that generally upright window 142 crops or reduces the first portion of primary FOV 115 and allows only a portion of the first portion to pass through. First mirror 185 is positioned directly in a third path P3 of a second portion of primary FOV 115 and is configured to redirect the second portion through generally horizontal window 140. The second portion of primary FOV 115 that is redirected from first mirror 185 through generally horizontal window 410 can fill 50-100% of generally horizontal window 140. In some implementations, an area of the second portion of primary FOV 115 redirected through generally horizontal window 140, taken along a plane of generally horizontal window 140, is greater than an area of generally horizontal window 140 such that generally horizontal window 140 crops or reduces the second portion of primary FOV 115 and allows only a portion of the second portion to pass through. For example, a width of generally horizontal window 140 could be greater than a length of generally horizontal window 140 such that a width of the second portion of primary FOV 115 allowed to pass through generally horizontal window 140 is greater than a length of the second portion of primary FOV 115 allowed to pass through generally horizontal window 140.

It will be understood that, although the components of the imaging assembly 109 refer to mirrors, other refractive and/or reflective components (e.g., prisms) may be utilized instead. Additionally, it will be understood that the bioptic reader 100 may include additional, alternate, or fewer components. For example, the imaging assembly 109 may include one or more optical assemblies, each including a different number of mirrors. For example, a first optical assembly may include an even number of optical components while a second optical assembly may include an odd number of optical components. Depending on the implementation, the first optical assembly may provide a representative (e.g., normal) view of an object, while the second optical assembly may provide a mirrored view of the object. In other implementations, the first optical assembly may provide the mirrored view and the second optical assembly may include the representative view. In further implementations, the first optical assembly and the second optical assembly may provide either of the representative or mirrored view depending on a bit indicator, either determined/set by the user and/or at configuration at the time of manufacture. In some implementations, the first optical assembly and second optical assembly may include at least some of the same number of optical components. For example, the first optical assembly may include all of the optical components of the second optical assembly, and an additional optical component. Depending on the implementation, the optical components may include at least one of mirrors, prisms, and/or any other such reflecting and/or refracting component.

Referring next to FIG. 2, a block diagram of an example architecture for an imaging device such as bioptic indicia reader 100 and/or handheld imaging device 150 is shown. For at least some of the reader implementations, an imaging assembly of the imaging device 200 includes a light-detecting sensor or imager 241 operatively coupled to, or mounted on, a printed circuit board (PCB) 242 in the imaging device 200 as shown in FIG. 2. In an implementation, the imager 241 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imager 241 over a field of view along an imaging axis 246 through the window 208. The imager 241 may also include and/or function as a monochrome sensor and, in further implementations, a color sensor. It should be understood that the terms “imager”, “image sensor”, and “imaging sensor” are used interchangeably herein. Depending on the implementation, imager 241 may include a color sensor such as a vision camera in addition to and/or as an alternative to the monochrome sensor. In some implementations, the imager 241 is or includes a barcode reading module (e.g., a monochromatic imaging sensor). In further implementations, the imager 241 additionally or alternatively is or includes a vision camera (e.g., a color imaging sensor). It will be understood that, although imager 241 is depicted in FIG. 2 as a single block, that imager 241 may be multiple sensors spread out in different locations of imaging device 200.

The return light is scattered and/or reflected from an object 118 over the field of view. The imaging lens 244 is operative for focusing the return light onto the array of image sensors to enable the object 118 to be imaged. In particular, the light that impinges on the pixels is sensed and the output of those pixels produce image data that is associated with the environment that appears within the FOV (which can include the object 118). This image data is typically processed by a controller (usually by being sent to a decoder) which identifies and decodes decodable indicia captured in the image data. Once the decode is performed successfully, the reader can signal a successful “read” of the object 118 (e.g., a barcode). The object 118 may be located anywhere in a working range of distances between a close-in working distance (WD1) and a far-out working distance (WD2). In an implementation, WD1 is about one-half inch from the window 208, and WD2 is about thirty inches from the window 208.

An illuminating light assembly may also be mounted in, attached to, or associated with the imaging device 200. The illuminating light assembly includes an illumination light source 251, such as at least one light emitting diode (LED) and at least one illumination lens 252, and preferably a plurality of illumination and illumination lenses, configured to generate a substantially uniform distributed illumination pattern of illumination light on and along the object 118 to be imaged by image capture. Although FIG. 2 illustrates a single illumination light source 251, it will be understood that the illumination light source 251 may include more light sources. At least part of the scattered and/or reflected return light is derived from the illumination pattern of light on and along the object 118.

An aiming light assembly may also be mounted in, attached to, or associated with the imaging device 200 and preferably includes an aiming light source 223, e.g., one or more aiming LEDs or laser light sources, and an aiming lens 224 for generating and directing a visible aiming light beam away from the imaging device 200 onto the object 118 in the direction of the FOV of the imager 241. It will be understood that, although the aiming light assembly and the illumination light assembly both provide light, an aiming light assembly differs from the illumination light assembly at least in the type of light the component provides. For example, the illumination light assembly provides diffuse light to sufficiently illuminate an object 118 and/or an indicia of the object 118 (e.g., for image capture). An aiming light assembly instead provides a defined illumination pattern (e.g., to assist a user in visualizing some portion of the FOV). Similarly, in some implementations, the illumination light source 251 and the aiming light source 223 are active at different, non-overlapping times. For example, the illumination light source 251 may be active on frames when image data is being captured and the aiming light source 223 may be active on frames when image data is not being captured (e.g., to avoid interference with the content of the image data).

In further implementations, the imaging device 200 may additionally emit an auditory cue, such as a chime, beep, message, etc. In still further implementations, the imaging device 200 may provide haptic feedback to a user, such as vibration (e.g., a single vibration, vibrating in a predetermined pattern, vibrating synchronized with flashing, etc.).

Further, the imager 241, the illumination source 251, and the aiming source 223 are operatively connected to a controller or programmed controller 258 (e.g., a microprocessor facilitating operations of the other components of imaging device 200) operative for controlling the operation of these components. In some implementations, the controller 258 functions as or is communicatively coupled to a vision application processor for receiving, processing, and/or analyzing the image data captured by the imager 241.

A memory 260 is connected and accessible to the controller 258. Preferably, the controller 258 is the same as the one used for processing the captured return light from the illuminated object 118 to obtain data related to the object 118. Though not shown, additional optical elements, such as collimators, lenses, apertures, compartment walls, etc. may be provided in the housing (e.g., as described above with regard to FIGS. 1D-1F). Although FIG. 2 shows the imager 241, the illumination source 251, and the aiming source 223 as being mounted on the same PCB 242, it should be understood that different implementations of the imaging device 200 may have these components each on a separate PCB, or in different combinations on separate PCBs. For example, in an implementation of the imaging device 200, the illumination LED source is provided as an off-axis illumination (i.e., has a central illumination axis that is not co-axial with the central FOV axis).

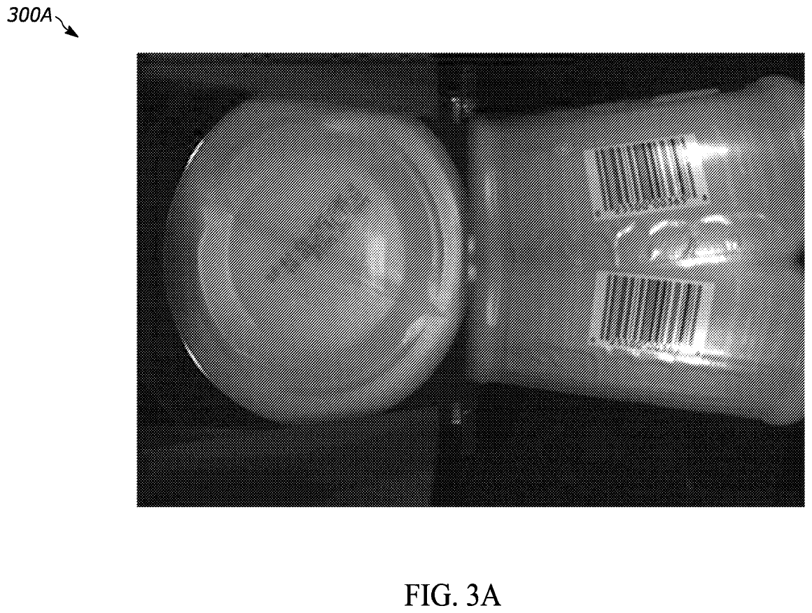

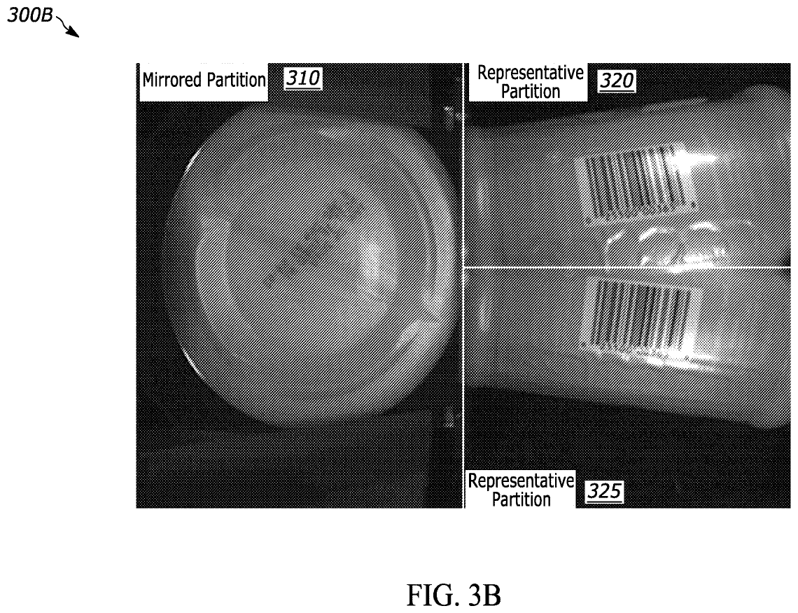

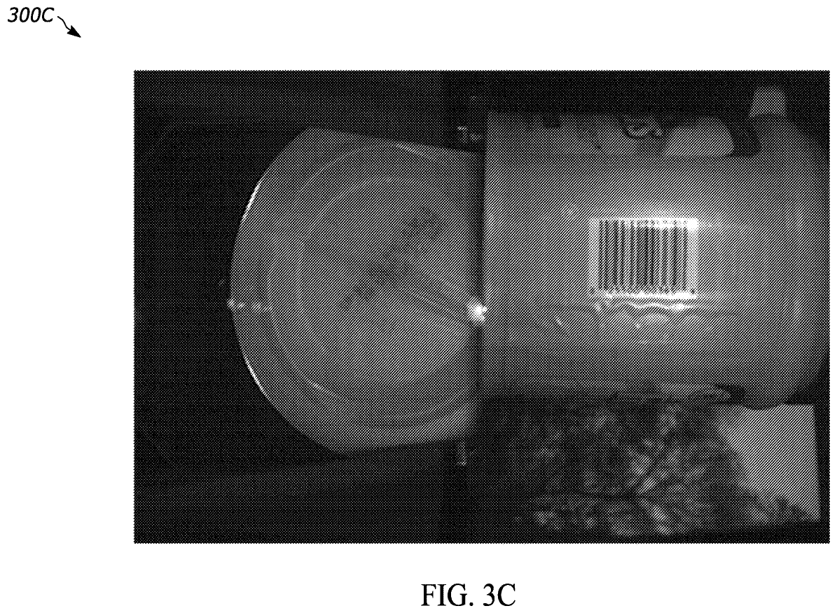

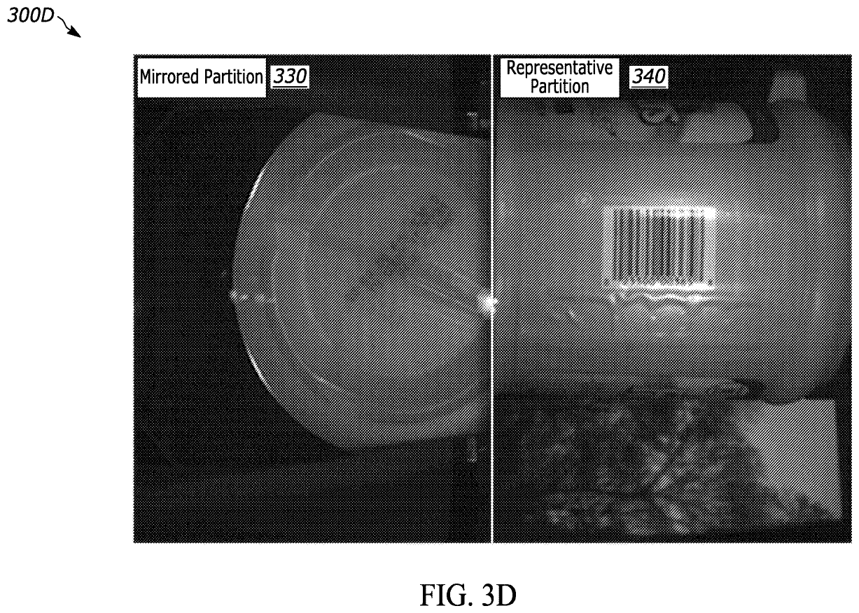

In the example of FIGS. 3A and 3B, the imaging device 200 captures an image 300A and partitions the image 300A into a partitioned image 300B with three partitions. In particular, the imaging device 200 can partition the image 300A into one or more representative partitions (e.g., representative partition 320 and representative partition 325) and/or one or more mirrored partitions (e.g., mirrored partition 310). Depending on the implementation, the imaging device 200 may be initially calibrated (e.g., in a factory at time of creation, by the user, etc.) to determine mirror split lines accurately. Based on the mirror split lines, the imaging device 200 can determine what portions of the image 300B should be partitioned into representative partitions (e.g., portions where the image 300B is normal) and mirrored (e.g., portions where the image 300B is reversed). In some implementations, the imaging device 200 sets a flag for at least some of the partitioned portions of the image 300B. Depending on the implementation, the imaging device 200 sets: (i) a mirrored flag for the mirrored partition 310, (ii) a normal flag for the representative partitions 320 and/or 325, (iii) a mirrored status flag for each partition, indicating normal for the representative partitions 320 and/or 325 and mirrored for the mirrored partition 310, and/or (iv) any other such indicating flag.

In the example of FIGS. 3C and 3D, the imaging device 200 captures an image 300C and partitions the image 300C into a partitioned image 300D with two partitions. In particular, the imaging device 200 can partition the image 300A into one or more representative partitions (e.g., representative partition 340) and/or one or more mirrored partitions (e.g., mirrored partition 330). Depending on the implementation, the imaging device 200 may partition the image 300C into the two partitions of partitioned image 300D similarly to the three partitions of the partitioned image 300B. As such, the imaging device 200 may similarly generate one or more flags as described above with regard to FIGS. 3A and 3B.

It will be understood that, although FIG. 3B illustrates an exemplary partitioned image 300B with three partitions and FIG. 3D illustrates an exemplary partitioned image 300D with two partitions, the imaging device 200 may partition an image into any appropriate number of partitions. For example, if an image has mirror split lines dividing the image into four sections (e.g., two representative and two mirrored, three representative and one mirrored, three mirrored and one representative, etc.), the imaging device 200 may partition the image into four partitions. Similarly, the imaging device 200 may further subdivide the partitions into additional partitions depending on one or more additional factors (e.g., presence of a decode indicia, presence of one or more characteristics on a detected object, presence of an object, etc.) in addition to and/or in place of the mirror split lines.

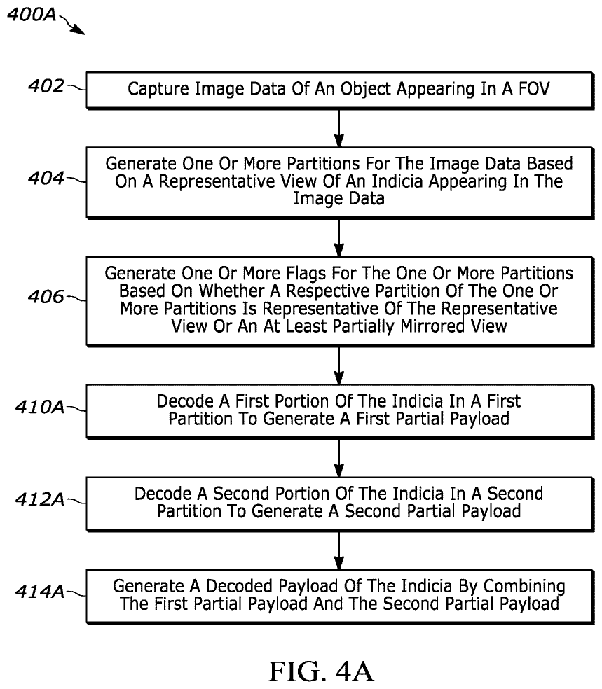

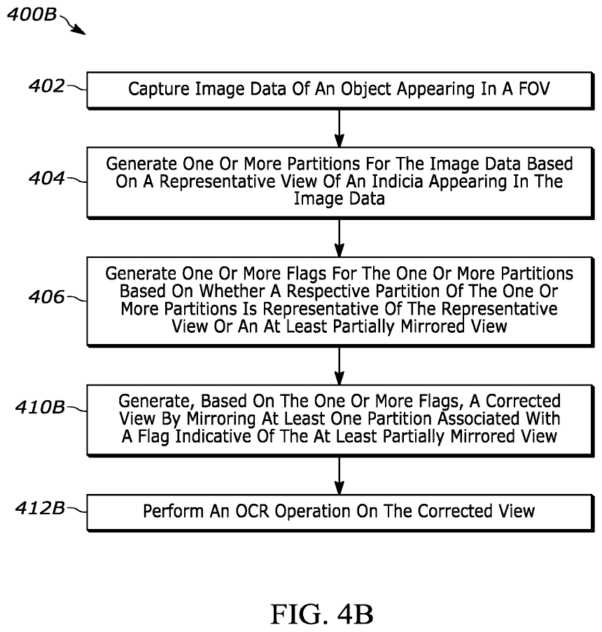

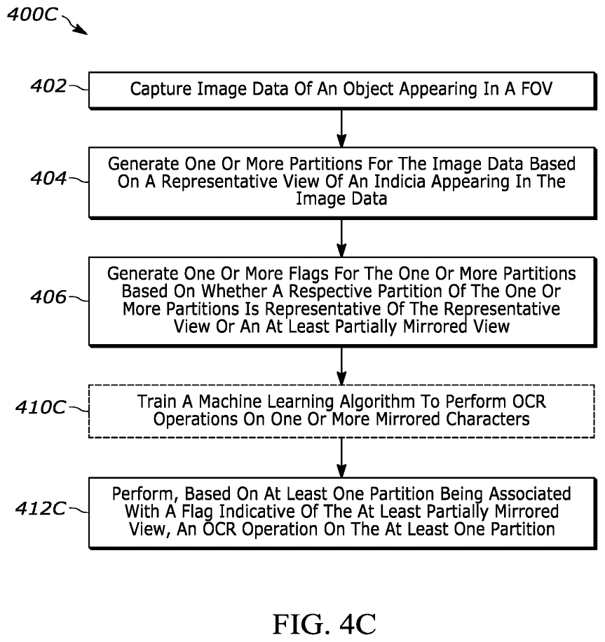

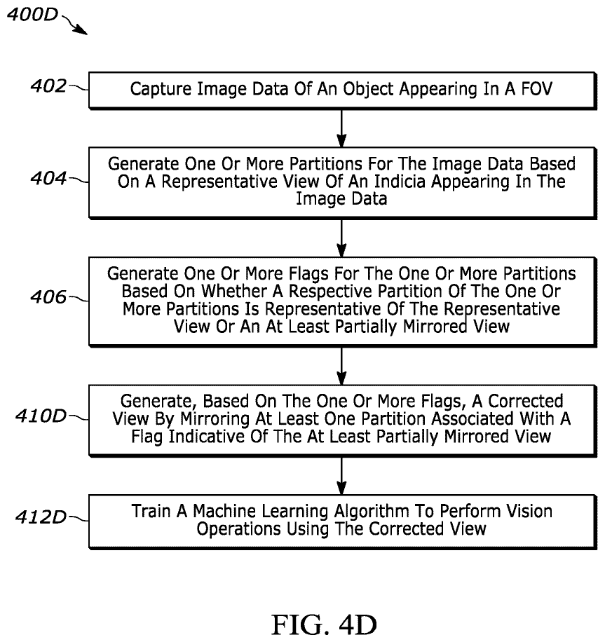

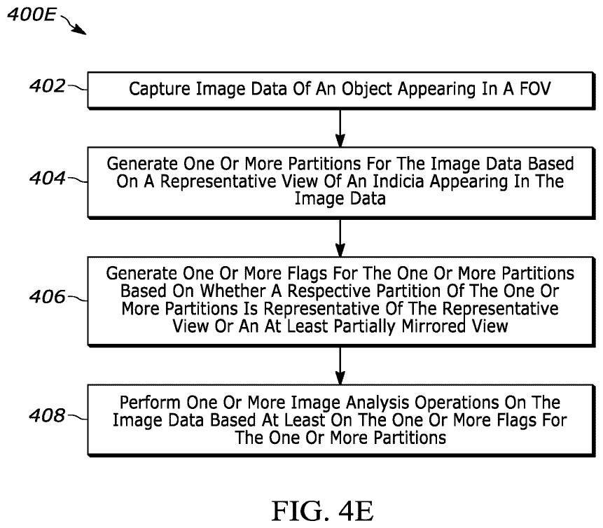

Referring next to FIG. 4A, the method 400A illustrates a flow diagram of an example method for generated a decoded payload of an indicia (e.g., on an object, such as object 118) using one or more partitions of an image (e.g., as described above with regard to FIGS. 3A-3D). Although the method 400 is described below with regard to imaging device 200 and components thereof as illustrated in FIG. 2, it will be understood that other similarly suitable imaging devices and/or components may be used instead (e.g., bioptic indicia reader 100, handheld imaging device 150, etc.).

At block 402, the imaging device 200 captures image data of an object (e.g., object 118) appearing in a field of view (FOV) using the imaging assembly. In some implementations, the imaging device 200 captures the image data using multiple views (e.g., from multiple imagers, cameras, and/or other such imaging devices). In further implementations, the imaging device 200 includes multiple mirrors (and/or other such reflective or refractive elements, such as prisms, etc.) that provide multiple views in the imaging data. In some such implementations, the imaging device 200 stores one or more mirror split lines calibrated (e.g., at time of creation in the factory, by a user, etc.) based on the multiple views. The mirror split lines may differ depending on the individual unit, model, etc. Depending on the implementation, the imaging device 200 may capture the image data in multiple views in a single frame, in multiple frames, etc.

At block 404, the imaging device 200 generates one or more partitions for the image data based on a representative view (e.g., representative view 320, 325, or 340) of an indicia appearing in the image data. In some implementations, the imaging device 200 generates the partition(s) based on one or more mirror split lines calibrated for the imaging device 200. As such, in some such implementations, the imaging device 200 uses pre-calibrated mirror split lines to partition the image for performing image analysis operations on the partitions as described herein. Depending on the implementation, the mirror split lines are calibrated based on one or more physical characteristics of the imaging device 200. For example, the mirror split lines may be indicative of a change in mirror or detector providing the portion of the captured image.

At block 406, the imaging device 200 generates one or more flags for the one or more partitions based on whether a respective partition of the one or more partitions is representative of the representative view or an at least partially mirrored view of the indicia. In some implementations, the one or more flags are normal view flags indicative of whether a partition is a representative view (e.g., a view that is not reversed). For example, a representative view may include the flag, and a mirrored view does not include the flag. In further implementations, the one or more flags are mirrored view flags indicative of whether a partition is a mirrored view (e.g., a view that is reversed). For example, a mirrored view may include the flag, and a representative view does not include the flag. In still further implementations, the one or more flags are view status flags indicative of whether a partition is a representative or mirrored view. For example, a representative partition may have a flag with a first value indicative of a representative view, and a mirrored partition may have a flag with a second value indicative of a mirrored view. In some such implementations, the additional partitions (e.g., sub-partitions, partitions with no object, partitions with no label, etc.) may have a third value of flag and/or may be missing the flag.

In some implementations, the imaging device 400 includes the flag and/or metadata associated with the image in the image data. For example, the imaging device 400 may append the flag data and/or metadata at the end of an image. In further implementations, when interpreting the generated flag, the imaging device 400 determines a partition to which the flag is associated based on a memory address of the flag (e.g., based on data encoded in an upper left corner of the image, lower right corner of the image, etc.).

At block 410A, the imaging device 200 decodes a first portion of the indicia in a first partition to generate a first partial payload. At block 412A, the imaging device 200 decodes a second portion of the indicia in a second partition to generate a second partial payload. In some implementations, the imaging device 200 determines to decode the first and/or second portion of the indicia responsive to an indication to perform a visual operation. For example, the imaging device 200 detects an indicia in the captured image data, receives an indication of an indicia from a user, etc. In further implementations, the imaging device 200 automatically attempts to perform an indicia decode operation. In still further implementations, the imaging device 200 decodes the first and/or second portion of the indicia responsive to detecting the flag(s) generated at block 406 and/or otherwise determining that at least part of the image including the indicia is reversed. For example, the imaging device 200 determines that an indicia is at least partially present in a representative partition and in a mirrored partition. As such, the imaging device 200 determines to decode the first and/or second portion of the indicia differently rather than decoding the entirety of the indicia using a same technique.

In some implementations, the imaging device 200 decodes the first portion of the indicia in a first direction and decodes the second portion of the indicia in a second direction. For example, the imaging device 200 may decode the first portion of the indicia forwards (e.g., a standard reading direction) and may decode the second portion of the indicia backwards (e.g., a mirrored reading direction). In some such implementations, the indicia is a 2D indicia (e.g., a QR code, 2D watermark, a 2D barcode, and/or any other such 2D indicia as described herein). In some such implementations, the imaging device 200 decodes the 2D indicia in a mirrored view (e.g., a QR code). In other such implementations, the imaging device 200 corrects at least a portion of the image data by reversing the corresponding portion before decoding the indicia (e.g., a 2D data matrix). In some implementations in which the indicia is a 1D indicia (e.g., a standard barcode), the imaging device decodes the 1D indicia agnostic to direction of reading.

At block 414A, the imaging device 200 generates a decoded payload of the indicia by combining the first partial payload and the second partial payload. In some implementations, the imaging device 200 combines the first partial payload and the second partial payload directly. In further implementations, the imaging device 200 combines the first partial payload and the second partial payload by removing any redundancies and/or overlap in the partial payloads. For example, the if a portion of the indicia is visible in both a representative view and a mirrored view, the imaging device 200 may decode the portion as part of the first partial payload and the second partial payload and may subsequently determine that the partial payloads have overlap. In further implementations, the imaging device 200 may initially detect the overlap and may decode the corresponding portion of the indicia as part of either the first partial payload or the second partial payload.

Referring next to FIG. 4B, the method 400B illustrates a flow diagram of an example method for performing an optical character recognition (OCR) operation on an element of an object (e.g., object 118) using a corrected view generated using one or more flags (e.g., as described above with regard to FIGS. 3A-3D). Although the method 400B is described below with regard to imaging device 200 and components thereof as illustrated in FIG. 2, it will be understood that other similarly suitable imaging devices and/or components may be used instead.

In some implementations, blocks 402, 404, and 406 of FIG. 4B are similar and/or identical to blocks 402, 404, and 406 of FIG. 4A. As such, implementations and examples described with regard to the method 400A of FIG. 4A may apply as appropriate to the method 400B of FIG. 4B.

At block 410B, the imaging device 200 generates, based on the one or more flags, a corrected view by mirroring at least one partition associated with a flag indicative of the at least partially mirrored view. In some implementations, the imaging device 200 generates the corrected view by generating a bounding box in the image data. In particular, the imaging device 200 may detect a portion of the image data to be reversed (e.g., the object 118, one or more indicia associated with the object 118, text visible in the image data, one or more machine vision characteristics visible in the image data, etc.) and generate the bounding box for the detected portion of the image data. Depending on the implementation, the imaging device 200 may generate the bounding box using a localizing model, or more determined coordinates of the detected portion of the image data, a neural network (NN) configured to generate bounding boxes (e.g., a convolutional neural network (CNN) trained to recognize/identify objects in an image and/or generate the bounding boxes (e.g., using labeled training data, using unlabeled training data, etc.)) based on a recognized object, indicia, characteristic, etc. Depending on the implementation, the neural network and/or other such model is trained using mirrored and/or unmirrored image to detect objects. In still further implementation, the training data additionally includes a flag indicative of a mirrored status (e.g., mirrored or not) of the training data.

In further implementations, the imaging device 200 may generate the corrected view by mirroring a particular partition of the generated partitions (e.g., based on a presence of a flag or lack thereof). In still further implementations, the imaging device 200 may generate the corrected view by mirroring the entirety of the image data. In yet still further implementations, the imaging device 200 may generate the corrected view by mirroring the image data based on the presence of one or more indicia, a start of an indicia, an end of an indicia, an edge of an indicia (e.g., denoting a bound of a 2D barcode), and/or any other such detectable portion of an indicia.

At block 412B, the imaging device 200 performs an OCR operation on the corrected view. In further implementations, the imaging device 200 additionally or alternatively performs an indicia decode operation (e.g., as described above with regard to FIG. 4A), a machine vision operation (e.g., as described below with regard to FIG. 4D), and/or any other such image analysis operation as described herein (e.g., as described below with regard to FIG. 4E). Depending on the implementation, the imaging device 200 may perform OCR to recognize one or more characters in the image data using the corrected view and/or the representative view. For example, an object 118 may include a number “2” on a label and/or associated indicia. If the imaging device 200 analyzes the mirrored view directly, the “2” may appear to be the number “5” instead. When analyzing the corrected view, the imaging device 200 instead correctly reads the “2” as “2”. Alternatively, in some implementations, the imaging device performs an OCR operation to determine whether to change to a corrected view. For example, the imaging device 200 may perform an OCR operation to detect a character that may be easy for the imaging device 200 to misread (e.g., according to a list of characters, predetermined training data, historical data, etc.) and, responsive to a detection of the mirrored flag, determine to generate the corrected view before analysis.

In some implementations, such OCR operations may be or include the conversion of printed or handwritten text into machine-encoded (and therefore machine-readable) text. In particular, OCR operations may be or include accurately recognizing and interpreting characters from images or documents. The OCR operations may additionally be or include feature extraction (e.g., extraction of features such as edges, corners, and gradients from an input image to represent the characteristics of each character). Depending on the implementation, the OCR algorithm and/or model may perform or utilize histogram of oriented gradients (HOG) techniques, scale-invariant feature transform (SIFT) techniques, or convolutional neural networks (CNNs) for feature extraction. In some implementations (e.g., where multiple characters are present in an image), the OCR algorithm and/or model may additionally use or perform segmentation techniques to separate individual characters for recognition.

In further implementations, once features are extracted and characters segmented, the imaging device 200 may utilize classification algorithms to identify each character. In some implementations, the classification algorithms may include machine learning algorithms like Support Vector Machines (SVM) or k-nearest neighbors (KNN), as well as deep learning models such as neural networks for classification tasks in OCR.

In some implementations, OCR operations may additionally include preprocessing steps such as image enhancement, noise reduction, and binarization to improve the quality of the input image and enhance the clarity of characters. Similarly, the OCR operations may additionally include postprocessing techniques like language modeling, spell checking, and context analysis to improve the accuracy of OCR results and correct errors introduced during the recognition process.

Referring next to FIG. 4C, the method 400C illustrates a flow diagram of an example method for performing an OCR operation on a mirrored view of an element of an object (e.g., object 118) using a mirrored partition as indicated by a partition flag (e.g., as described above with regard to FIGS. 3A-3D). Although the method 400C is described below with regard to imaging device 200 and components thereof as illustrated in FIG. 2, it will be understood that other similarly suitable imaging devices and/or components may be used instead.

In some implementations, blocks 402, 404, and 406 of FIG. 4C are similar and/or identical to blocks 402, 404, and 406 of FIGS. 4A and 4B. As such, implementations and examples described with regard to the methods 400A and 400B of FIGS. 4A and 4C may apply as appropriate to the method 400C of FIG. 4C.

At block 410C, the imaging device 200 and/or a communicatively coupled computing device may train a machine learning algorithm to perform OCR operations on one or more mirrored characters. Depending on the implementation, the machine learning algorithm may be performed by and/or include a pattern matching algorithm. In some implementations, the imaging device 200 and/or a communicatively coupled computing device may train the machine learning algorithm using image data including flags as described above. As such, the machine learning algorithm may be trained such that the machine learning algorithm only analyzes image data as reversed when the flag is present or missing, as described above.

Depending on the implementation, the algorithm may be trained using various machine learning (ML) and/or artificial intelligence (AI) techniques. In some implementations, the algorithm and/or model may be trained on the imaging device 200 and/or another device (not shown) communicatively coupled to the imaging device 200. Depending on the implementation, the algorithm may be trained using training data from the imaging device 305 (e.g., captured by a user performing the training) and/or external databases (not shown) including historical image data and/or historical device data corresponding to historical images. The trained algorithm may then be applied to newly captured image data to perform operations as described herein (e.g., OCR operations, indicia decoding operations, etc.).

In various aspects, the trained algorithm may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the algorithm and/or model may comprise a library or package executed on the imaging device (and/or other computing devices not shown). For example, such libraries may include, but are not limited to, the TENSORFLOW based library, the PYTORCH library, and/or the SCIKIT-LEARN Python library.

Machine learning, as referenced herein, may involve identifying and recognizing patterns in existing data in order to facilitate making predictions or identification for subsequent data (such as using the trained algorithm on newly captured data to perform OCR operations (and/or other such operations as described herein) on image data for an object).

Machine learning model(s) may be created and trained based upon example data (e.g., “training data”) inputs or data (which may be termed “features” and “labels”) to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided to subsequent inputs for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by a server, computing device, or other such processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

At block 412C, the imaging device 200 performs an OCR operation on at least one partition based on the at least one partition being associated with a flag indicative of the at least partially mirrored view. In some such implementations, the imaging device 200 performs the OCR operation using the machine learning algorithm trained at block 410C. In some implementations, the imaging device 200 analyzes the image data by analyzing pixels in the image data in a mirrored orientation. For example, the imaging device 200 may utilize an algorithm on mirrored images that looks at each pixel in the opposite order of a standard OCR algorithm for representative views (e.g., moving from bottom-right to top-left rather than vice versa). In further implementations, the training data for the algorithm is on reversed images at block 410C and the algorithm is trained to analyze reversed features, characters, text, etc.

Referring next to FIG. 4D, the method 400D illustrates a flow diagram of an example method for training a machine learning algorithm to perform OCR operations on an element of an object (e.g., object 118) using a corrected view generated using a partition flag (e.g., as described above with regard to FIGS. 3A-3D). Although the method 400D is described below with regard to imaging device 200 and components thereof as illustrated in FIG. 2, it will be understood that other similarly suitable imaging devices and/or components may be used instead.

In some implementations, blocks 402, 404, and 406 of FIG. 4D are similar and/or identical to blocks 402, 404, and 406 of FIGS. 4A-4C. As such, implementations and examples described with regard to the methods 400A-400C of FIGS. 4A-4C may apply as appropriate to the method 400D of FIG. 4D.

At block 410D, the imaging device 200 generates, based on the one or more flags, a corrected view by mirroring at least one partition associated with a flag indicative of the at least partially mirrored view. Depending on the implementation, the imaging device 200 may generate the corrected view similarly to block 410B of FIG. 4B.

At block 412D, the imaging device 200 and/or another computing device communicatively coupled to the imaging device 200 trains a machine learning algorithm to perform vision operations using the corrected view. Depending on the implementation, the imaging device 200 and/or other computing device may perform the training as described above with regard to block 410C of FIG. 4C. Depending on the embodiment, the vision operation may include (i) a machine vision operation, (ii) an OCR operation, (iii) a decode operation, and/or (iv) any other such visual-based operation as described herein.

Referring next to FIG. 4E, the method 400E illustrates a flow diagram of an example method for performing an image analysis operation on an image of an object (e.g., object 118) using one or more partitions and/or partition flags (e.g., as described above with regard to FIGS. 3A-3D). Although the method 400E is described below with regard to imaging device 200 and components thereof as illustrated in FIG. 2, it will be understood that other similarly suitable imaging devices and/or components may be used instead.

In some implementations, blocks 402, 404, and 406 of FIG. 4E are similar and/or identical to blocks 402, 404, and 406 of FIGS. 4A-4D. As such, implementations and examples described with regard to the methods 400A-400D of FIGS. 4A-4D may apply as appropriate to the method 400E of FIG. 4E.

At block 408, the imaging device 200 may perform one or more image analysis operations on the image data based at least on the one or more flags for the one or more partitions. Depending on the implementation, the image analysis operation(s) may include at least one of the operations described herein with regard to FIGS. 4A-4D (e.g., a decode operation, an OCR operation, a machine vision operation, etc.).

Embodiments of the present disclosure may have certain advantages over traditional approaches. For example, using a single assembly to provide both aiming light and a decode indication can reduce complexity, footprint, costs, etc. Similarly, providing a visible decode indication using the aiming light may improve a rate at which users recognize the indication, as auditory cues may be missed in a noisy or busy environment and an illumination system has a large FOV across which the system projects light, diffusing the light and reducing overall visibility.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging device, comprising:
an imaging assembly configured to capture image data of a payload-encoding indicia, the image data including a first field of view (FOV) and a second FOV; and
a computer-readable media storing machine readable instructions that, when executed, cause the imaging device to:
capture, using the imaging assembly, the image data of the payload-encoding indicia, wherein an at least partially mirrored perspective of the second FOV is mirrored compared to a representative perspective of the first FOV;
determine, based on whether a respective partition of one or more partitions of the image data is indicative of a representative view of the payload-encoding indicia in the representative perspective or an at least partially mirrored view of the payload-encoding indicia in the at least partially mirrored perspective, one or more constraints for at least some of the one or more partitions; and
perform one or more image analysis operations on the image data based at least on the one or more constraints for the at least some of the one or more partitions.

2. The imaging device of claim 1, wherein performing the one or more image analysis operations includes:
decoding a first portion of the payload-encoding indicia in a first partition of the one or more partitions to generate a first partial payload;
decoding a second portion of the payload-encoding indicia in a second partition of the one or more partitions to generate a second partial payload; and
generating a decoded payload of the payload-encoding indicia by combining the first partial payload and the second partial payload.

3. The imaging device of claim 2, wherein determining the one or more constraints includes:
determining whether at least one of the first partition or the second partition is mirrored based on one or more flags indicative of an orientation status of the respective partition;
wherein decoding the first portion and decoding the second portion are responsive to determining whether at least one of the first partition or the second partition is mirrored based on the one or more flags.

4. The imaging device of claim 2, wherein:
decoding the first portion is performed in a first direction; and
decoding the second portion is performed in a second direction.

5. The imaging device of claim 1, wherein generating the one or more partitions is further based on one or more calibrated split lines indicative of the representative view and the at least partially mirrored view.

6. The imaging device of claim 5, wherein the one or more calibrated split lines are based on one or more physical characteristics of the imaging device.

7. The imaging device of claim 1, wherein the payload-encoding indicia is a 2-Dimensional (2D) payload-encoding indicia.

8. The imaging device of claim 7, wherein the computer-readable media stores further machine readable instructions that, when executed, cause the one or more processors to:
generate, based on a positioning of the payload-encoding indicia in the image data, a bounding box encompassing at least a portion of the image data.

9. The imaging device of claim 8, wherein the computer-readable media stores further machine readable instructions that, when executed, cause the one or more processors to:
generate, based on the one or more constraints and the bounding box, a corrected view by mirroring the at least the portion of the image data; and
wherein performing the one or more image analysis operations includes decoding the corrected view to generate a corrected decode.

10. The imaging device of claim 9, wherein the performing the one or more image analysis operations further includes:
decoding a remainder of the image data to generate a mirrored decode; and
combining the mirrored decode and the corrected decode.

11. The imaging device of claim 1, wherein the computer-readable media stores further machine readable instructions that, when executed, cause the one or more processors to:
generate, based on the one or more constraints, a corrected view by mirroring at least a partition of the one or more partitions; and
wherein performing the one or more image analysis operations includes decoding the corrected view.

12. The imaging device of claim 1, wherein the computer-readable media stores further machine readable instructions that, when executed, cause the one or more processors to:
generate, based on the one or more constraints, a corrected view by mirroring the image data; and
wherein performing the one or more image analysis operations includes decoding the corrected view.

13. The imaging device of claim 1, wherein performing the one or more image analysis operations includes:
decoding the payload-encoding indicia based on the at least partially mirrored view of the payload-encoding indicia using a decode algorithm configured to decode mirrored barcodes.

14. The imaging device of claim 1, wherein the imaging assembly includes:
a first optical assembly comprising an even number of optical components; and
a second optical assembly comprising an odd number of optical components;
wherein one of the first FOV or the second FOV is a first optical assembly FOV of the first optical assembly and a different one of the first FOV or the second FOV is a second optical assembly FOV of the second optical assembly.

15. The imaging device of claim 14, wherein the even number of optical components includes an even number of mirrors and the odd number of optical components includes an odd number of mirrors.

16. A method implemented in an imaging device including an imaging assembly, comprising:
capturing, by one or more processors and using the imaging assembly, image data of a payload-encoding indicia, the image data including a first field of view (FOV) and a second FOV, wherein an at least partially mirrored perspective of the second FOV is mirrored compared to a representative perspective of the first FOV;
determining, by the one or more processors and based on whether a respective partition of one or more partitions of the image data is indicative of a representative view of the payload-encoding indicia in the representative perspective or an at least partially mirrored view of the payload-encoding indicia in the at least partially mirrored perspective, one or more constraints for at least some of the one or more partitions; and
performing, by the one or more processors, one or more image analysis operations on the image data based at least on the one or more constraints for the at least some of the one or more partitions.

17. The method of claim 16, wherein performing the one or more image analysis operations includes:
decoding a first portion of the payload-encoding indicia in a first partition of the one or more partitions to generate a first partial payload;
decoding a second portion of the payload-encoding indicia in a second partition of the one or more partitions to generate a second partial payload; and
generating a decoded payload of the payload-encoding indicia by combining the first partial payload and the second partial payload.

18. The method of claim 17, wherein determining the one or more constraints includes:
determining, by the one or more processors, whether at least one of the first partition or the second partition is mirrored based on one or more flags indicative of an orientation status of the respective partition;
wherein decoding the first portion and decoding the second portion are responsive to determining whether at least one of the first partition or the second partition is mirrored based on the one or more flags.

19. The method of claim 17, wherein:
decoding the first portion is performed in a first direction; and
decoding the second portion is performed in a second direction.

20. The method of claim 16, wherein generating the one or more partitions is further based on one or more calibrated split lines indicative of the representative view and the at least partially mirrored view.

21. The method of claim 20, wherein the one or more calibrated split lines are based on one or more physical characteristics of the imaging device.

22. The method of claim 16, wherein the payload-encoding indicia is a 2-Dimensional (2D) payload-encoding indicia.

23. The method of claim 22, further comprising:
generating, by the one or more processors and based on a positioning of the payload-encoding indicia in the image data, a bounding box encompassing at least a portion of the image data.

24. The method of claim 23, further comprising:
generating, by the one or more processors and based on the one or more constraints and the bounding box, a corrected view by mirroring the at least the portion of the image data; and
wherein performing the one or more image analysis operations includes decoding the corrected view to generate a corrected decode.

25. The method of claim 24, wherein the performing the one or more image analysis operations further includes:
decoding a remainder of the image data to generate a mirrored decode; and
combining the mirrored decode and the corrected decode.

26. The method of claim 16, further comprising:
generating, by the one or more processors and based on the one or more constraints, a corrected view by mirroring at least a partition of the one or more partitions; and
wherein performing the one or more image analysis operations includes decoding the corrected view.

27. The method of claim 16, further comprising:
generating, by the one or more processors and based on the one or more constraints, a corrected view by mirroring the image data; and
wherein performing the one or more image analysis operations includes decoding the corrected view.

28. The method of claim 16, wherein performing the one or more image analysis operations includes:
decoding the payload-encoding indicia based on the at least partially mirrored view of the payload-encoding indicia using a decode algorithm configured to decode mirrored barcodes.

29. The method of claim 16, wherein capturing the image data includes:
capturing at least one of the first FOV or the second FOV using a first optical assembly of the imaging assembly, the first optical assembly comprising an even number of optical components; and
capturing at least a different one of the first FOV or the second FOV using a second optical assembly of the imaging assembly, the second optical assembly comprising an odd number of optical components.

30. The method of claim 29, wherein the even number of optical components includes an even number of mirrors and the odd number of optical components includes an odd number of mirrors.

31. An imaging device, comprising:
an imaging assembly configured to capture image data of an object appearing in a field of view (FOV);
one or more processors; and
a computer-readable media storing machine readable instructions that, when executed, cause the one or more processors to:
capture, using the imaging assembly, the image data of the object appearing in the FOV;
generate one or more partitions for the image data based on a representative view of an indicia appearing in the image data;
generate one or more flags for the one or more partitions based on whether a respective partition of the one or more partitions is representative of the representative view or an at least partially mirrored view of the indicia; and
perform one or more image analysis operations on the image data based at least on the one or more flags for the one or more partitions.
